(19) United States
(12) Patent Application Publication
(10) Pub. No.: US 2024/0210164 A1
(43) Pub. Date: Jun. 27, 2024

(54) Non-Contact Dynamic Displacement Measurement of Structures Using a Moving Laser Doppler Vibrometer

(71) Applicant: UNM Rainforest Innovations, Albuquerque, NM (US)

(72) Inventors: Piyush Garg, Albuquerque, NM (US); Mahmoud Reda Taha, Albuquerque, NM (US); Fernando Moreu, Albuquerque, NM (US)

(73) Assignee: UNM Rainforest Innovations, Albuquerque, NM (US)

(21) Appl. No.: 18/544,117

(22) Filed: Dec. 18, 2023

Related U.S. Application Data
(60) Provisional application No. 63/433,080, filed on Dec. 16, 2022.

(51) Int. Cl. G01B 11/14; G01B 9/02; G01H 9/00

(52) U.S. Cl. CPC G01B 11/14; G01B 9/02045; G01H 9/00

(57) ABSTRACT

A system for measuring the dynamic displacement of a structure reference free comprising: a laser Doppler vibrometer (LDV); an unmanned aerial system (UAS), said LDV mounted on said UAS; and a processor in communication with said LDV adapted to compensate error in the LDV output due to the UAS movement.

### RELATED APPLICATIONS

This application claims priority to U.S. Provisional Application No. 63/433,080, filed on Dec. 16, 2023, which is incorporated herein in its entirety.

### STATEMENT REGARDING FEDERALLY SPONSORED RESEARCH & DEVELOPMENT

This invention was made with government support by the Transportation Research Board grant 160416-0399. The government has certain rights in the invention.

### INCORPORATION BY REFERENCE OF MATERIAL SUBMITTED ON A COMPACT DISC

Not applicable.

### BACKGROUND OF THE INVENTION

As of 2017, according to the American Society of Civil Engineers (ASCE) infrastructure report card, the majority of the infrastructure in the US received a grade of D or less with an overall grade of D+ (ASCE 2017). For the past decade, the infrastructure in the US has constantly received poor grades (ASCE 1988, 1998, 2001, 2005, 2009, 2013, 2017). The investment required to maintain the infrastructure has been constantly on the rise. The investment estimate required for maintaining the infrastructure by 2025 currently stands at 4.59 trillion, with an available investment of 2.526 trillion and an investment gap of 2.064 trillion (ASCE 2017). There is a need to prioritize the maintenance and repair within the infrastructure network. Engineers and managers are looking for data acquisition that inform their decisions about the safety and maintenance prioritization (Moreu 2015). Collecting data about the health of individual structures within the network can inform managers on which structures to prioritize first.

The US railroad network is one of the best freight systems in the world (FRA 2015). Railroads in America carry up to 40% of the total cross-country freight (FRA 2010). The network of railways is 140,000 miles long (AAR 2013 2015) with around 100,000 bridges (IRC 2017). In other words, on average there is a bridge every 1.4 mile. Thus, the performance of bridges is critical for the safe operation of the rail networks. As of today, about 50% of the railroad bridges are more than 100 years old (AREMA 2003), making the maintenance of bridges a priority. The underperformance of bridges could pose a significant danger to the safety of train operations, cause derailments, delay in network operation, and loss in terms of valuable time, resources, and costs.

To ensure operation safety, the bridges are inspected regularly. However, most of these methods either involve visual inspection (AAR 2016). However visual inspection does not always provide reliable information (Agdas 2015) and owners and researchers are considering Structural Health Monitoring (SHM) of bridges, including sensing. According to a survey conducted in 2010, displacement measurement under dynamic loading is a priority for the assessment of railroad bridges because it provides objective information about the performance of the bridges (Moreu and LaFave 2012).

The traditional methods for measurement of bridge displacement include using contact sensors such as Linear Variable Differential Transducer (LVDT) and accelerometers (Nagayama and Spencer 2007, Moreu et. al. 2014, Hoag et. al. 2017, Ozdagli et. al. 2017, Gomez et. Al. 2017). However, this approach is impractical in many situations, where mounting a sensor becomes difficult, due to the terrain such as large openings. Besides, use of accelerometers to calculate displacement by measuring acceleration, and then double integrating the readings to obtain displacement as demonstrated by Yang et. al. (2005), can add drifting errors and is not always reliable. In recent years, researchers have used global positioning systems (GPS) as contact sensors for displacement measurement (Wang et. al. 1991, Ashkenazi and Roberts 1997, Meng, et. al. 2007, Watson et. al. 2007, Yi et. al. 2013). However, the readings from a GPS unit are not accurate for detecting small displacements as in case of real time train loading. Smyth and Wu (2007), Kogan et. al. (2008), and Moschas and Stiros (2013) fused GPS data along with the measurement captured with accelerometers and inertial measurement unit (IMU) for the purpose of accuracy. However, this setup still needs manual installation and regular monitoring which is not always feasible.

To overcome the drawbacks of the contact sensors, a number of researchers studied the feasibility of non-contact sensors in measuring bridge displacements. For example, Panos and Stiros (2007, 2013) proposed the use of a robotic total station (RTS) for non-contact displacement detection of highway bridges. However, this system is dependent on right atmospheric conditions to give accurate output. Another widely studied method for non-contact displacement measurement is image processing (Olaszek 1999, Lee and Shinozuka 2006, Fukuda et. al. 2010, Feng et. al. 2015, Feng et. al. 2015). However, the instruments must be set up close to the target, which is not always possible, and the readings are not accurate if measured from a distance. Also, the accuracy of measurement is also dependent on lighting and environmental conditions, and there are complex algorithms required for post-processing to extract information from the images captured. Another factor affecting the use of this method is that it always requires either calibration of camera properties or some reference for comparison and displacement detection.

To overcome the problem of distance and accuracy regarding the image processing and capturing techniques, there have been attempts to use a camera mounted drone or unmanned aerial system (UAS) for structural health monitoring (Ellenberg et. al 2014, 2016, 2017 Kim et. al. 2015, Yoon et. al. 2016, Ham et. al. 2016, Hawken et. al. 2017). The technique of using camera mounted on UAS for SHM, although more effective, still requires a reference for image processing, complicated algorithms, and extensive post processing for accurate bridge displacement and deformation detection. While this approach solves the problem of accessibility to remote locations and hazardous conditions, it still fails to address the shortcomings of other SHM techniques. Also, this setup is incapable of measuring transverse dynamic displacements.

Laser Doppler Vibrometer (LDV) is another device which measures vibration of the target. This system has successfully found its use in displacement measurement of railroad bridges (Nassif et. al. 2005). LDV is used as a non-contact sensor, placed on a rigid ground surface near the target. However, the range of distances over which vibrometers operate is generally high and can even be used between 200 mm to 200 m from the target (Polytec Inc., 2017). Also, the amount of post-processing required to obtain the data from a vibrometer is minimal compared to the other approaches mentioned above and can be implemented for real time displacement measurement. Even with these advantages, there is still a disadvantage in the sense that, LDV requires a rigid surface near the target

### BRIEF SUMMARY OF THE INVENTION

In one embodiment, the present invention can measure dynamic displacement of a structure reference free using a laser Doppler vibrometer (LDV) mounted on an unmanned aerial system (UAS) and presents algorithms and signal processing to compensate error in the LDV output due to the UAS movement.

In another embodiment, the present invention provides a method, approach and solution that measures bridge displacement enabled by the use of non-contact and reference-free moving vibrometers.

In another embodiment, the present invention provides a method of compensating for measurement errors due to the angular and linear movement of the vibrometer to obtain accurate transverse displacement measurements of a bridge.

In another embodiment, the present invention achieves a signal difference between the measured outputs of a moving LDV system and a LVDT that is between 10% to 15% peak and 2% to 5% RMS, which are generally accepted by railroad managers as a valid level of accuracy for field applications.

In another embodiment, the present invention provides a method and system for measuring bridge displacement using a moving vibrometer wherein the vibrometer is placed on an UAS and flown close to the bridge even in remote and inaccessible conditions.

In other aspects of the present invention, the response of the vibrometer is analyzed for the motions to which the UAS is subjected. Since the frequency of a laser signal is high (474 GHz), the smallest motions of the drone result in a large error being introduced to the vibration readings, and these errors need to be corrected to obtain the final readings. Accordingly, the present invention provides algorithms for these movement corrections.

In other aspects of the present invention, the algorithms compensate for the errors introduced due to these motions, and the measured signal can be corrected.

It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

In the drawings, which are not necessarily drawn to scale, like numerals may describe substantially similar components throughout the several views. Like numerals having different letter suffixes may represent different instances of substantially similar components. The drawings illustrate generally, by way of example, but not by way of limitation, a detailed description of certain embodiments discussed in the present document.

FIG. 1 shows motion of a UAS along six degrees of freedom.

FIG. 2 depicts reading by the vibrometer at an angular position.

FIG. 3 shows the dynamic displacement of vibrometer.

FIG. 4 shows the dynamic pitching of vibrometer.

FIG. 5 shows a laboratory setup.

FIG. 6 shows a layout for different vibrometer configurations.

FIG. 7 shows the randomly moving vibrometer with accelerometers measuring the angles and LVDT measuring the displacements.

FIGS. 8A, 8B and 8C show the response of displacement and velocity decoder of the vibrometer vs LVDT at 1 meter from the target for (a) sine wave, (b) El Centro earthquake, and (c) bridge displacement under train crossing.

FIGS. 9A, 9B and 9C show the signal difference comparison for vibrometer vs LVDT at 1 meter from the target for (a) sine wave, (b) El Centro earthquake, and (c) bridge displacement under train crossing.

FIGS. 10A, 10B, 10C and 10D show the response of displacement and velocity decoder of vibrometer vs LVDT, 3 feet from the target with 30 degrees pitch angle (a) measured vibrometer signal and (b) corrected vibrometer signal, and 30 degrees pitch as well as yaw angle (c) measured vibrometer signal and (d) corrected vibrometer signal.

FIGS. 11A, 11B, 11C and 11D show the corrected response of displacement and velocity decoder of vibrometer vs LVDT, 3 feet from target, 30 degrees pitch angle for (a) cape Mendocino earthquake and (c) bridge displacement due to train loading, and 30 degrees pitch as well as yaw angles for (b) cape Mendocino earthquake and (d) bridge displacement due to train loading.

FIG. 12 shows the measured and corrected value of the vibrometer displacement output vs the actual output measured by the LVDT.

FIG. 13 shows the corrected reading of vibrometer vs actual reading form LVDT.

FIG. 14 shows the experimental layout for the field testing using an LDV mounted on a UAS.

FIG. 15 shows the field testing using an LDV mounted on a UAS.

FIG. 16 shows the vibrometer assembly to the UAS.

FIG. 17 shows the UAS tethered to the ground along with vibrometer cable.

FIGS. 18A, 18B and 18C show the vibrometer output vs LVDT from the UAS distance of (a) 4 meters from the target, (b) 7 meters from the target (Trial 1), and (c) 7 meters from the target (Trail 2).

FIG. 19 shows the frequency domain plot for corrected signal of the vibrometer mounted on a UAS 7 meters from the target vs LVDT.

FIG. 20. Spectral output of filtered LVDT and LDV signals.

FIGS. 21A, 21B and 21C. Comparison of dynamic displacements measured by LDVT and LDVT at (a) 4 meters from the target, (b) 7 meters from the target (trial 1), and (c) 7 meters from the target (Trial 2).

FIGS. 22A, 22B and 22C show the focused dynamic displacements measured with LDV vs LVDT with UAS distance of (a) 4 meters from the target, (b) 7 meters from the target (Trial 1), and (c) 7 meters from the target (Trail 2).

FIGS. 23A and 23B show the (a) Peak signal difference comparison between filtered vibrometer and LVDT signals and (b) RMS signal difference comparison between filtered vibrometer and LVDT signals.

FIGS. 24A and 24B show the (a) Peak signal difference comparison between filtered vibrometer and LVDT signals and (b) RMS signal difference comparison between filtered vibrometer and LVDT signals.

### DETAILED DESCRIPTION OF THE INVENTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed method, structure or system. Further, the terms and phrases used herein are not intended to be limiting, but rather to provide an understandable description of the invention.

### Methodology

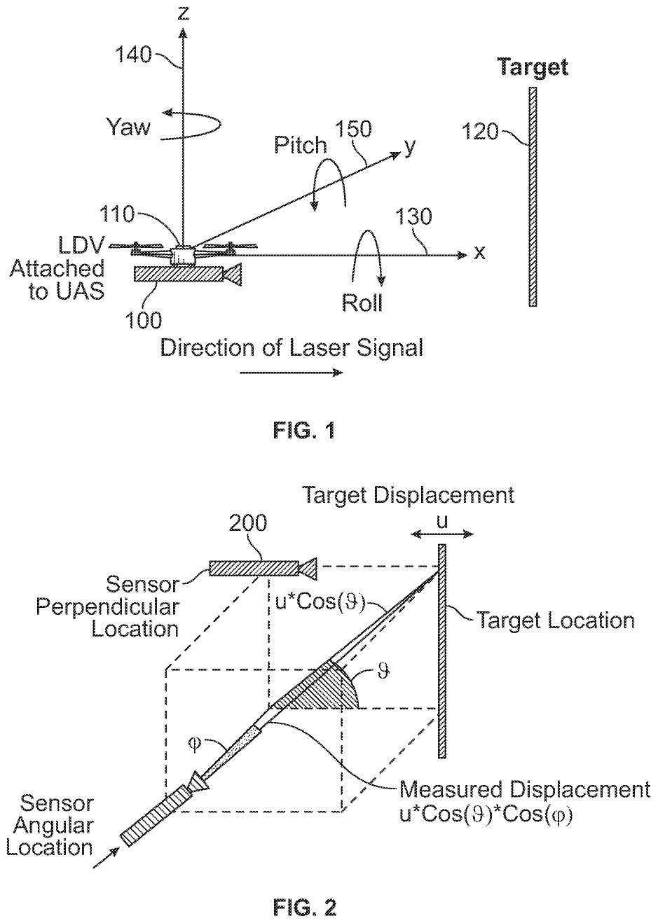

In one aspect, the present invention provides a system and method wherein the displacement of the railroad bridges and other structures may be measured using a moving vibrometer. In a preferred embodiment, a Laser Doppler Vibrometer (LDV) 100 may be used with UAS 110 as shown in FIG. 1.

It works on the principle of doppler effect, which shifts the frequency between transmitted and reflected waves from a moving target depending on target's velocity and direction of motion. The weight of the sensor head may be around 3 pounds, and the total vibrometer assembly is around 5 pounds.

For a target moving with velocity ‘v’ and for a known wavelength of the emitted wave ‘λ’, the shift in the frequency ‘f_{d}’ is given by

$${f}_{d} = 2 * \frac{v}{λ} \qquad ( 1 )$$

To accurately determine the velocity of a moving target, the measurement of frequency shift for a known value of ‘λ’ is required.

### Correction for LDV Movement

In principle, the laser doppler vibrometer reads the change in velocity as a vector quantity, and the angle that the target surface makes with the laser signal from the vibrometer is critical to the measurement of the displacement. Thus, the output of the vibrometer reads the exact displacement when the target surface is perpendicular to the laser. In the FIG. 1, vibrometer 100 will measure the exact target displacement when it points along the x direction towards the target 120. As UAS 110 moves along x direction 130, the distance of the vibrometer from the target changes and so does the vibrometer output. Also, with yaw 140 and pitch 150 motion, the laser signal will not always be perpendicular to the target surface, changing the distance from the target. Changes in y and z direction does not affect the output of the vibrometer as the distance from the target doesn't change.

In one aspect, the present invention corrects the readings for these angles and movement of drone along the x direction.

### For Static Positioning of Vibrometer

If the vibrometer makes pitch angle of ‘θ’ and yaw angle of ‘φ’ with the target surface, the present invention can visualize the reading at the final location due to these angles as seen in FIG. 2, where Sensor Perpendicular Location 200 is the point where the vibrometer reads maximum displacement. When the sensor is at any location besides the perpendicular location, the readings by the vibrometer are equivalent to the product of the cosine of the pitch and yaw angles. If the vibrometer reading at the perpendicular location is ‘u’, then at a pitch angle of ‘θ’ and a yaw angle of ‘φ’, the measured reading ‘uₘ’ is the cosine components of the pitch and yaw angles of ‘d’ and is represented as

$${u}_{m} = u * cos ( θ ) * cos ( φ ) \qquad ( 2 )$$

Thus, the actual displacement ‘u’ can be obtained by using

$$u = ( \frac{{u}_{m}}{cos ( θ ) * cos ( φ )} ) \qquad ( 3 )$$

### Dynamic Motion of Vibrometer

It is important to analyze the dynamic motion of the vibrometer, as the UAS is a dynamic system, and the vibrometer is subject to these motions when attached to a UAS. The dynamic motion can be either a change in the distance from the target, or in the angles (roll, pitch, and yaw), or any combination of those two.

Change in Distance from Target

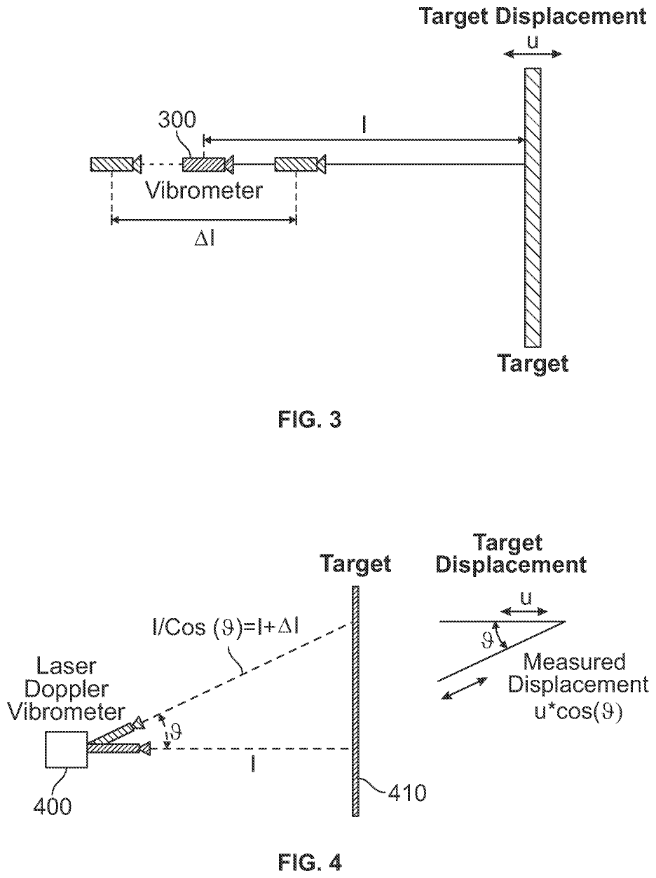

As shown in FIG. 3, of the three directions (x, y, and z) that a vibrometer 300 can move in, only the movement in x direction changes the output of vibrometer. This motion along x axis can be visualized as seen in FIG. 3. As shown, ‘l’ is the distance between the vibrometer and the target, while ‘Δl’ is the change in the distance. For the target vibration ‘u’, the measured vibration ‘uₘ’ is calculated as

$${u}_{m} = u + Δ l \qquad ( 4 )$$

Thus, by measuring the change in the distance of the vibrometer from the target, the present invention can correct to measure the actual vibration as

$$u = {u}_{m} - Δ l \qquad ( 5 )$$

### Change in Angle

Of the three angular motions (pitch, yaw, and roll), only the pitch and yaw motions of the vibrometer affects the displacement and velocity readings. When the vibrometer moves dynamically, the angle made by the laser signal with the target changes dynamically. Along with this, the distance travelled by the laser signal between the vibrometer and target also changes. The change in this distance also depends on the angle that the laser makes with the target. This can be visualized from FIG. 4. As shown, ‘l’ is the distance between the vibrometer 400 and the target 410, while ‘Δl’ is the change in the distance. The angle ‘θ’ is either pitch angle, yaw angle, or the combination of the two angles. The target vibration or movement to be recorded is given by ‘uₘ’, where ‘uₘ’, can be calculated by using the equation 3 as

$${u}_{m} = {u}_{c} * cos ( θ ) \qquad ( 6 )$$

Thus, the vibrations corrected ‘u_{c}’ for the change in angle can be obtained by

$${u}_{c} = ( \frac{{u}_{m}}{cos ( θ )} ) \qquad ( 7 )$$

However, since the actual signal is affected by the change in angle as well as the apparent distance between the target and the vibrometer due to the angular motion, the actual vibration can be obtained by

$$u = {u}_{c} - Δ l \qquad ( 8 )$$

Where ‘Δl’ is given by

$$Δ l = ( l - ( \frac{l}{cos ( θ )} ) ) \qquad ( 9 )$$

### Random Motion of Vibrometer

The random movement of a vibrometer includes displacement and angular movement. For actual vibration ‘u’, angular movement ‘θ’, angular displacement ‘Δd’, and movement ‘Δl’ the measured displacement ‘uₘ’ is given by

$${u}_{m} = ( {u}_{c} - Δ d ) * cos ( θ ) \qquad ( 10 )$$

Where, u_{c} is the vibration measured from a laterally moving vibrometer, and is given by

$${u}_{c} = u + Δ l \qquad ( 11 )$$

Thus, from equations 10 and 11, the present invention obtains the actual vibration by correcting for all the movement as

$$u = ( \frac{{u}_{m}}{cos ( θ )} ) - Δ d - Δ l \qquad ( 12 )$$

### Calculations for Difference in LVDT and LDV Signals

The readings of the vibrometer are compared to the measurements from the LVDT to benchmark the operation capabilities of the vibrometer. Since the measurements from two different sensors are being compared, the difference in measurement is not treated as percentage error but just as a percentage difference. The max difference (E₁) and RMS difference (E₃) may be between the two readings can be calculated.

The maximum difference between the signals is obtained by comparing the values at each of the sampling point and then finding the maximum of this value from these differences. For ‘n’ sampling points, the difference can be obtained as:

$${E}_{1} ( i ) = ( abs ( LVDT ( i ) - LDV ( i ) ) ) , 1 \leq i \leq n \qquad ( 13 )$$

Thus, the percentage maximum difference from equation (13) may be obtained as

$${E}_{1} ( \% ) = ( \frac{max ( {E}_{1} )}{max ( abs ( LVDT ) )} ) * 100 \qquad ( 14 )$$

The RMS difference for ‘n’ sampling points is obtained as

$$RMSD = \sqrt{\frac{{\sum }_{i = 1}^{n} {( LVDT ( i ) - LDV ( i ) )}^{2}}{n}} \qquad ( 15 )$$

Thus, by using equation 14, the percentage RMS difference normalized by range) can be found as

$${E}_{2} = ( \frac{RMSD}{max ( LVDT ) - min ( LVDT )} ) * 100 \qquad ( 16 )$$

These performance criteria were successfully used for quantifying effectiveness of a newly developed wireless low-cost displacement sensor on comparison with LVDT and commercial accelerometers

### Test Setup

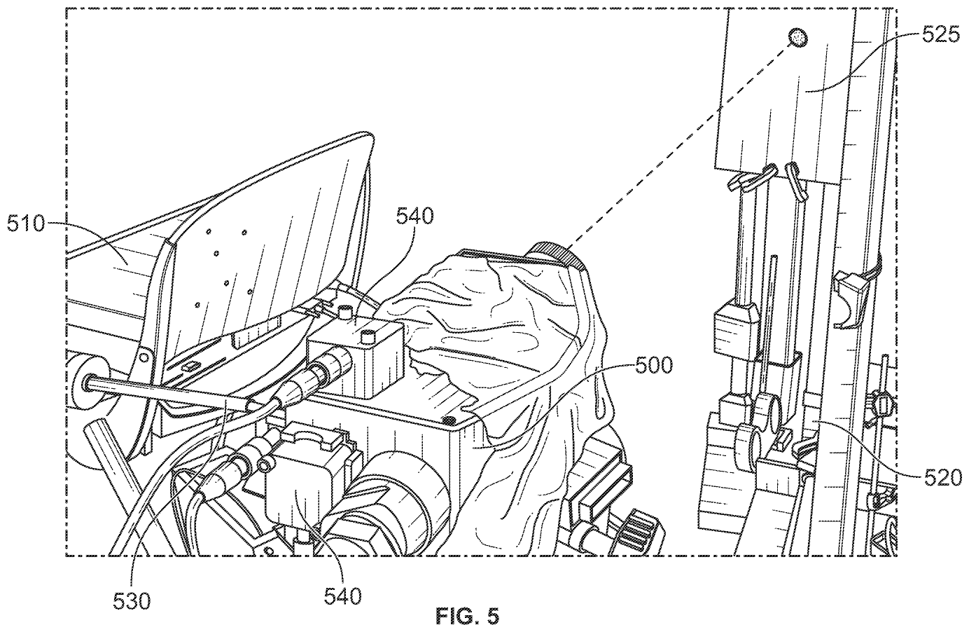

To validate the suitability of the present invention for mounting on a moving platform such as a drone, the response of the vibrometer for different positions and motions was analyzed. FIG. 5 shows the general setup used in the analysis. The vibrometer 500 that is used was a OFV-534 by Polytec. The vibrometer controller 510 used to tune the measurement parameters of LDV, such as sensitivity, signal bandwidth, and output filter, was a Polytec OFV-5000. This controller has a displacement decoder as well as a velocity decoder with separate output circuits for each decoder. A QUANSER Shake Table II 520 is used for simulating target vibration with single degree of freedom. This table holds target 525 and can be programed to generate vibrations in a multitude of displacement patterns including measured data from earthquakes or train loading for actual railroad bridges.

LVDT 530 was used for tracking the actual displacement of the shake table. The output of this LVDT is used as a reference or true displacement to determine the operation capabilities of the LDV. A rigid body in free space has six degrees of freedom, along with the x-axis, y-axis, and z-axis, and the roll, pitch, and yaw. In other words, the motion can be either translational, or rotational, or the combination of the both along one or multiple axes. To accurately measure the vibrometer motion along all the axes, capacitive accelerometers 540 may be used.

Table 1 shows the different states of motion in the setup to slowly simulate complete motion of the UAS.

TABLE 1
State of motion of vibrometer for different experimental setups

| | State of the motion | | | | | |
|---|---|---|---|---|---|---|
| Experiment | X direction | Y direction | Z direction | Roll | Pitch | Yaw |
| a | No motion | No motion | No motion | 0° | 0° | 0° |
| b | No motion | No motion | No motion | 0° | Fixed α° | Fixed θ° |
| c | No motion | No motion | No motion | 0° | Δα° | Δθ° |
| d | Δx | No motion | No motion | 0° | Δα° | Δθ° |

FIG. 6 shows the experimental layout of all the above configurations. These setups are discussed below in detail.

Fixed Vibrometer with Laser Signal Perpendicular to the Target

In this setup, the vibrometer is arranged in such a way that the laser signal from LDV 600 is directly perpendicular to the target 610 on table 620, and therefore parallel to the plane of vibration of the target. This arrangement gives the vibration of the target without any angular components, and the performance of the vibrometer can be benchmarked in comparison to the LVDT. Multiple tests were conducted using this setup to determine the response of the vibrometer for different signals, operating distances, and vibration frequencies and amplitudes. The aim of this test is to find the efficiency of the vibrometer in measuring signals with multi-frequency, multi-amplitude components such as earthquakes and bridge displacement.

Fixed Vibrometer with the Laser Signal at an Angle to the Target

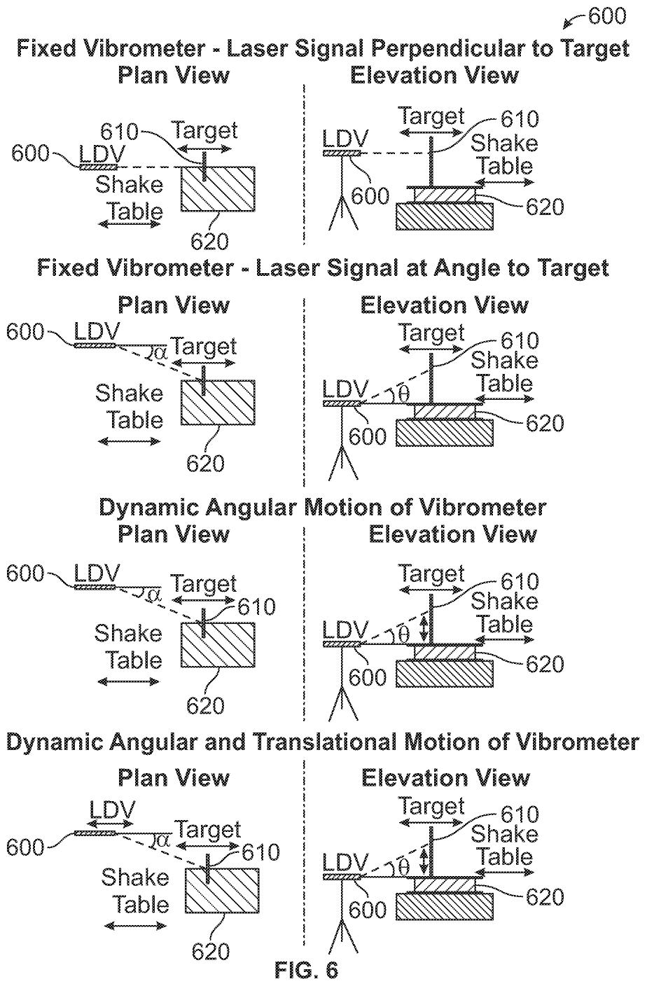

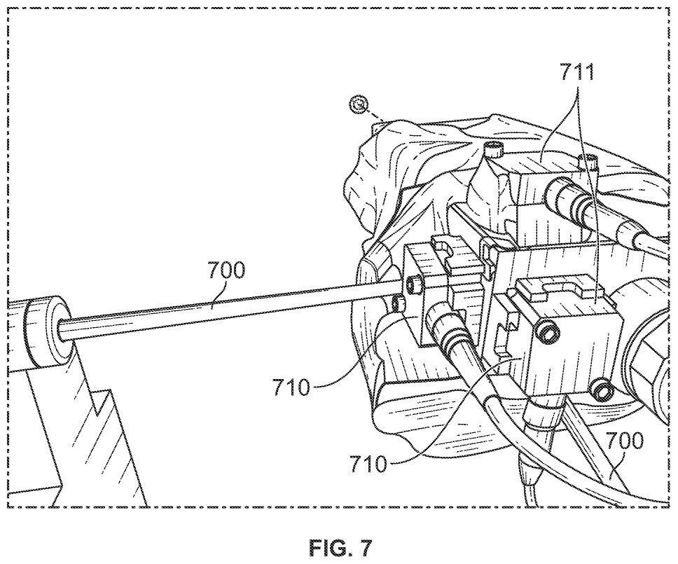

In this setup, the vibrometer is arranged in such a way that the laser signal points to the target at an angle. This setup is as seen in FIG. 7, where the angle ‘θ’ is the pitch angle of the vibrometer, and ‘α’ is the yaw angle. The aim of this test is to measure the pitch and yaw angles using capacitive accelerometers, and the correcting the readings of vibrometers due to these angles.

### Dynamic Angular Motion of the Vibrometer

It is essential to check the response of the vibrometer a dynamically moving arrangement and check if the errors introduced due to the motion can be corrected. In this setup, the vibrometer will be dynamically moved for the change in the angle of the vibrometer. The capacitive accelerometer measures the change in the vibrometer angle. The aim of this test is to use these calculated angles to correct the measured reading to get the actual vibration of the target.

### Random Dynamic Angular and Lateral Motions of the Vibrometer

In this section, a vibrometer moving in a random direction at a random angle is simulated. This setup is as seen in FIG. 7. The lateral movement of the vibrometer in any direction is measured with the LVDTs 700, and the capacitive accelerometers 710-711 are used to measure the angular motion of the vibrometer in pitch and yaw. This test is the closest realization of the movement of the UAS. The aim of this test is to correct for any movement of the vibrometer and get the actual vibration of the target.

### Results

Fixed Vibrometer with Laser Signal Perpendicular to the Target:

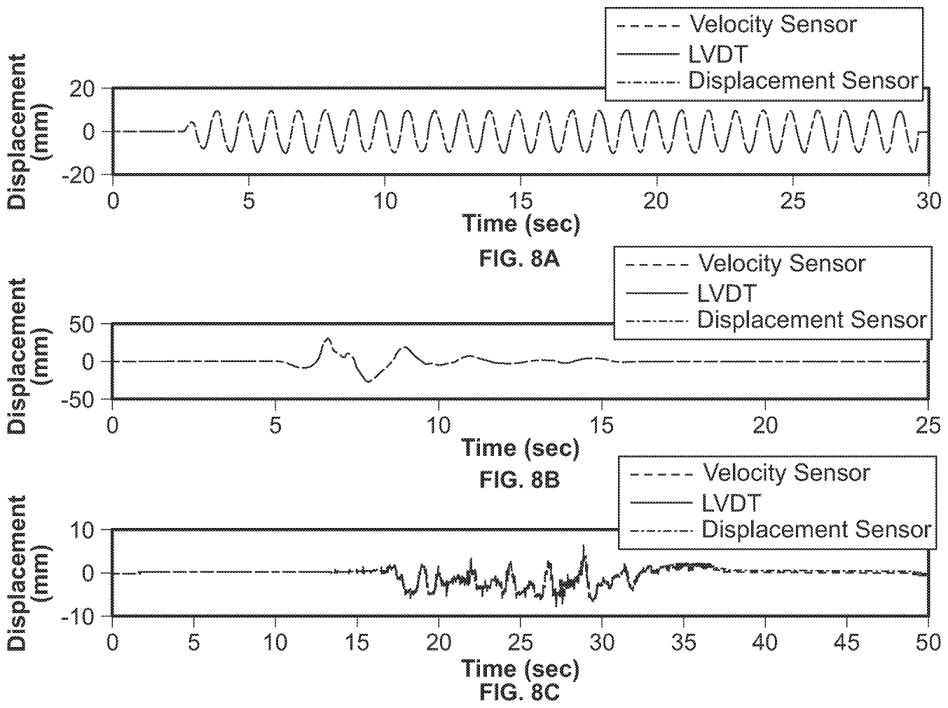

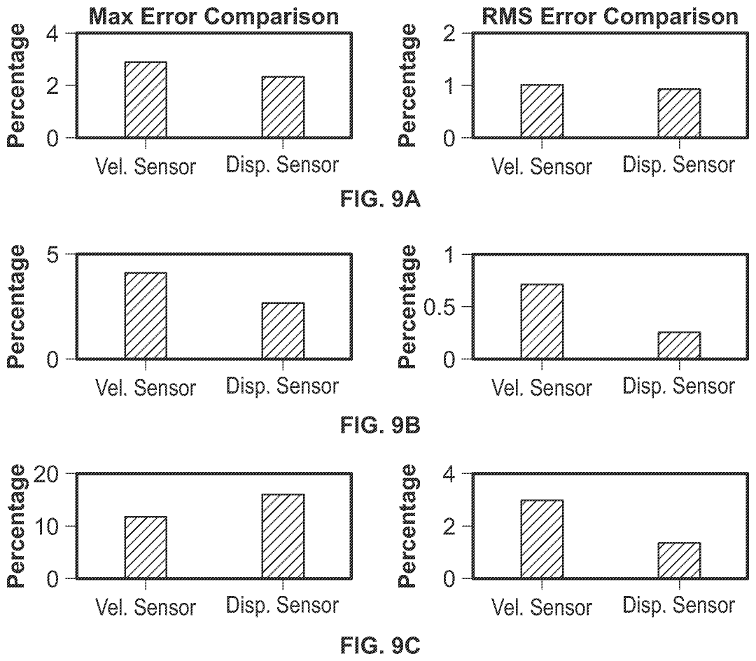

The first set of tests were conducted with the laser signal perpendicular to the target. The aim of this test was to validate the output of the vibrometer for multi-frequency, multi-amplitude signals, such as an earthquake signal, or bridge displacement for train loading along with pseudo-static displacement. The output seen in FIG. 8 and FIG. 9 shows the response collected by the velocity and displacement sensors of the vibrometer as compared to the actual output recorded by the LVDT. The vibrometer follows the output of the LVDT closely in amplitude as well as phase. The RMS errors are around or below 3%, which shows that the vibrometer accurately tracks all signals including pseudo-static displacements and signals with multiple amplitude and frequency components.

Fixed Vibrometer with the Laser Signal at an Angle to the Target:

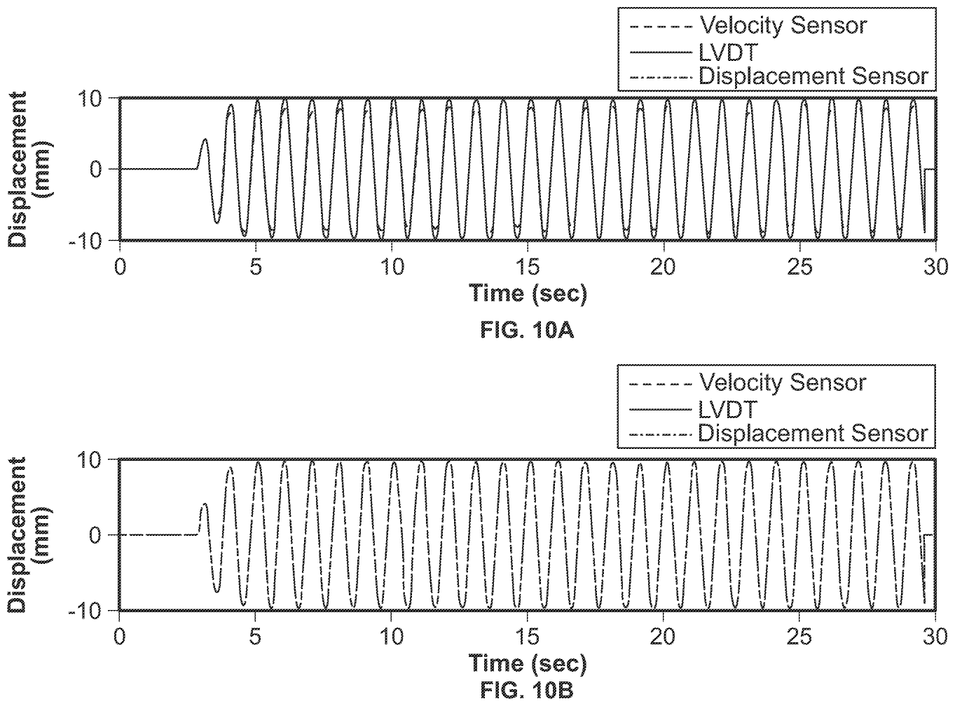

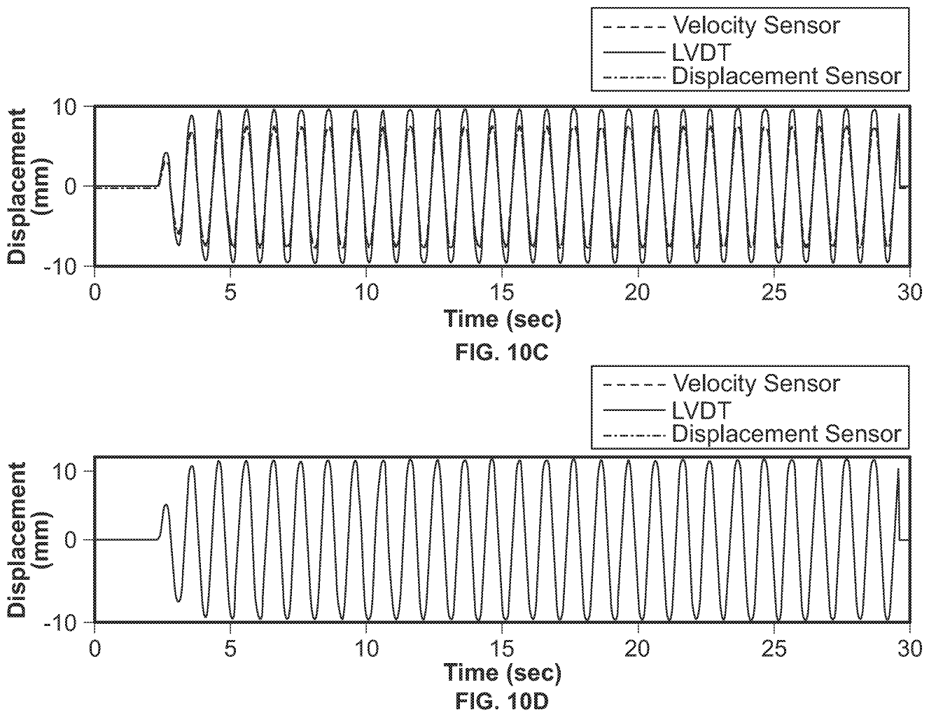

When the vibrometer is at an angle to the target, it records the cosine component of the target vibration in the direction of the vibrometer. For this reason, the measured output is always less than the actual vibration. This measured vibration can be corrected by using the angle of the vibration. The aim of this test was to validate the corrected output of vibrometer which is at an angle to the target, for earthquake and bridge displacements. FIG. 10 shows the output recorded by a vibrometer at a pitch angle of 30 degrees with the target, and both angles 30 degrees. When, measured output is corrected using the cosine of the tilt angles, corrected output matches the output of the LVDT. The max difference in the corrected readings and the actual vibration is less than 2% and the RMS difference is less than 1% for all the configurations.

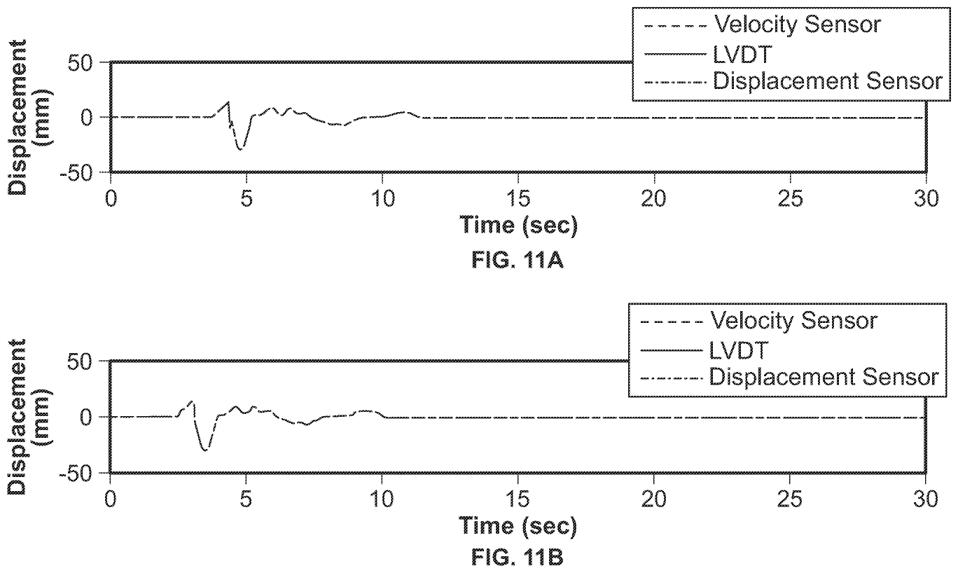

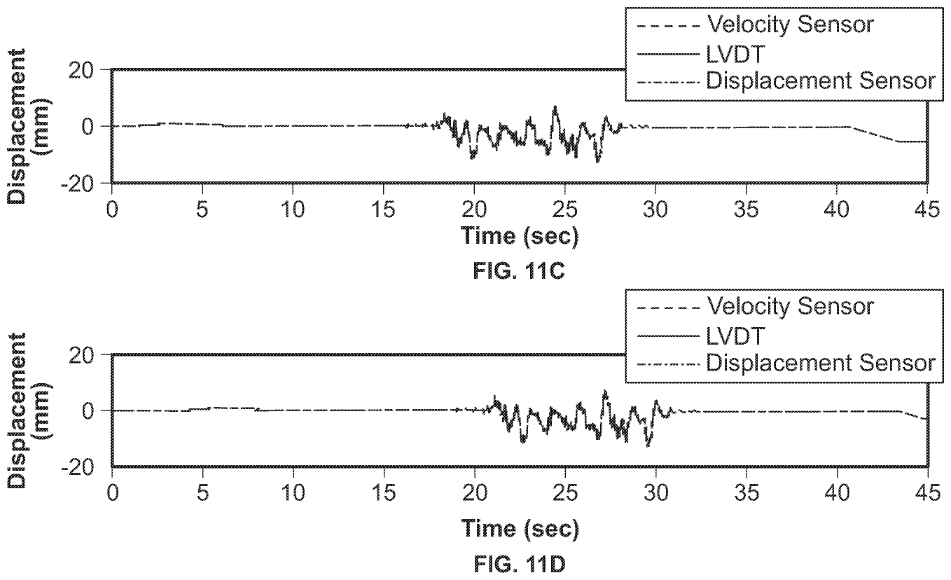

It can be seen from the FIG. 11 that the corrected signals of the vibrometer for the earthquake and bridge displacement match the LVDT. Thus, the correction algorithm for angular placement of the vibrometer works for all tests.

### Dynamic Angular Motion of the Vibrometer

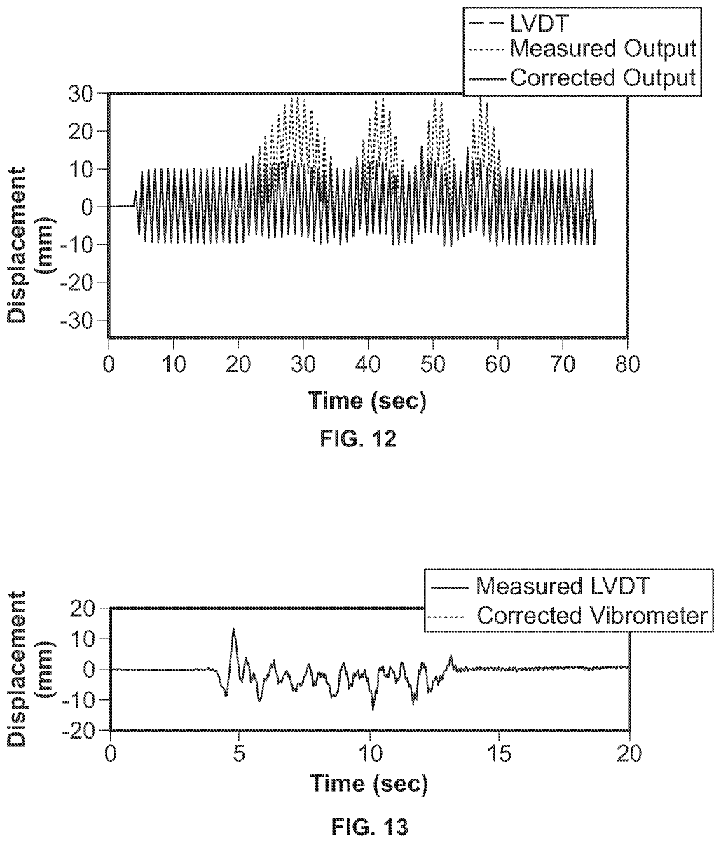

The aim of this test was to measure the dynamic angular movement of the vibrometer, and validated the output corrected for this angular movement. FIG. 12 shows the actual, measured, and corrected readings of the target vibration. The measured vibration is a result of the dynamic pitching motion of the vibrometer. This, when corrected using equations 8 and 9, the signal matches the actual vibration closely, and is in phase.

As seen, while the difference between the measured output and LVDT is very high, however, the corrected output matches the LVDT signal closely with the peak difference of 10% and the RMS difference of only 5%. Thus, it may be concluded that the algorithm developed for the correction of a dynamically pitching vibrometer works accurately.

### Random Dynamic Angular and Lateral Motions of the Vibrometer

The random motion of the vibrometer includes the motion of the vibrometer in translational as well as rotational degrees of freedom. Due to this random motion, the error is introduced in the measured signal. The aim was to correct for all the random movements of the vibrometer and validate the corrected output. When this measured vibrometer reading is corrected for the motion recorded by the LVDT and accelerometers, it can be seen in FIG. 13. It is observed that the corrected reading matches the actual reading exactly. Also, the maximum peak difference for corrected signal is around 15% and the RMS error is only around 1%. Thus, the algorithms designed for the correction of any motion of the vibrometer as a rigid body work accurately.

### Field Experimental Layout

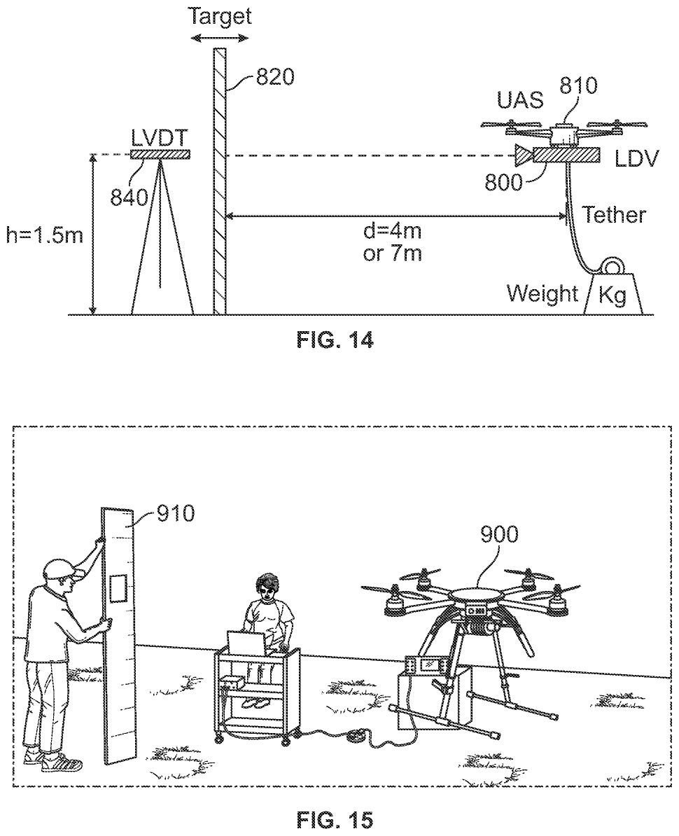

FIG. 14 shows the experimental layout for the field testing using a LDV 800 mounted onto a UAS 810. In the field testing, the movement of the target 820 is captured by the vibrometer mounted on a UAS. The measurements obtained by the vibrometer are compared to the actual displacements of the target measured by the LVDT 840.

The connection between the vibrometer and its data acquisition unit is a fixed optical fiber cable. To protect the vibrometer and to prevent injuries in case of sudden and unexpected UAS movement, the UAS is tethered to the ground using a heavy weight cable. In this comparison, the UAS system is not attached with any sensor for tracking its movement. The movement compensation approach was based on the sensor. In another approach, acceleration and gyro based inertial navigation units may be mounted on the UAS system, and assisted with a camera, to measure the precise movement of the UAS system while in flight. The objective of this comparison in the current field test setup is the proof of concept measurement of dynamic transverse displacements of railroad bridges using an LDV mounted on a UAS.

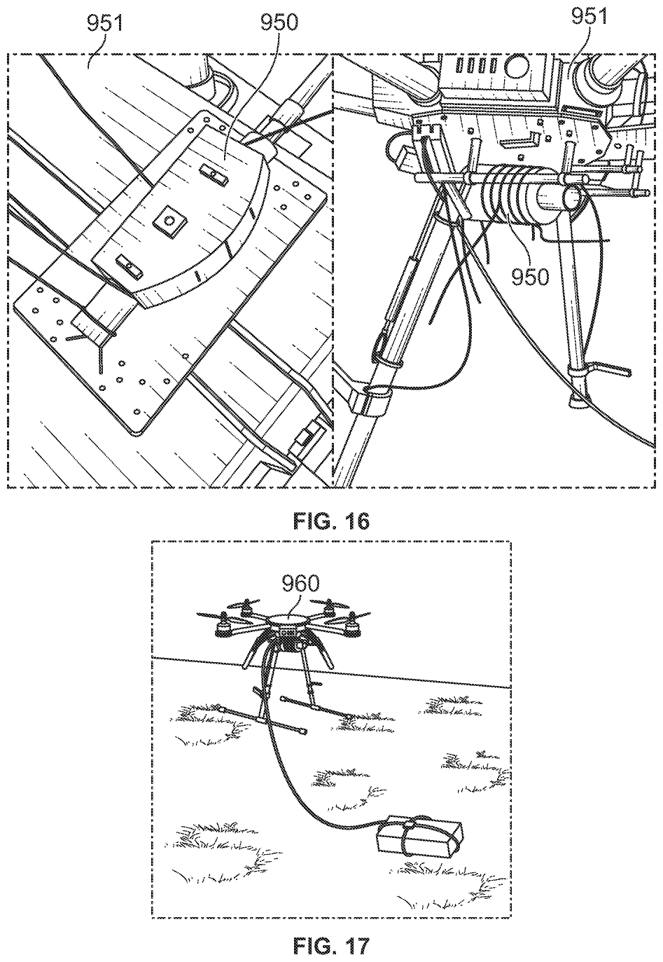

The implementation of the experimental setup for field testing is shown in FIG. 15. The pilot commands the UAS 900 to hover approximately 1.5 meters from the ground and the LVDT is arranged accordingly to point to the same location on the target. The UAS is flown at 4 to 7 meters from the target 910. The UAS is attached with the vibrometer using zip ties on a carbon fiber plates. In the field, the cloth was used between the plate and the vibrometer to eliminate the vibrations from the UAS motor into the LDV. FIG. 16 shows the vibrometer 950 assembly on the UAS 951.

The UAS was tethered to the ground along with the vibrometer cable to protect the vibrometer assembly as well as to prevent injuries. FIG. 17 shows the UAS 960 tethering.

The length of the connection between the LDV and the controller is fixed at 3 meters, and this is the optimal length of connection for the signal to travel through it without attenuation. The plank is manually moved in a way that simulates the movement of the railway bridge with various frequency and amplitude components including the pseudo static displacement. In this way, the field testing results can be used as a proof of concept prior to the testing of real railroad bridge.

### Results

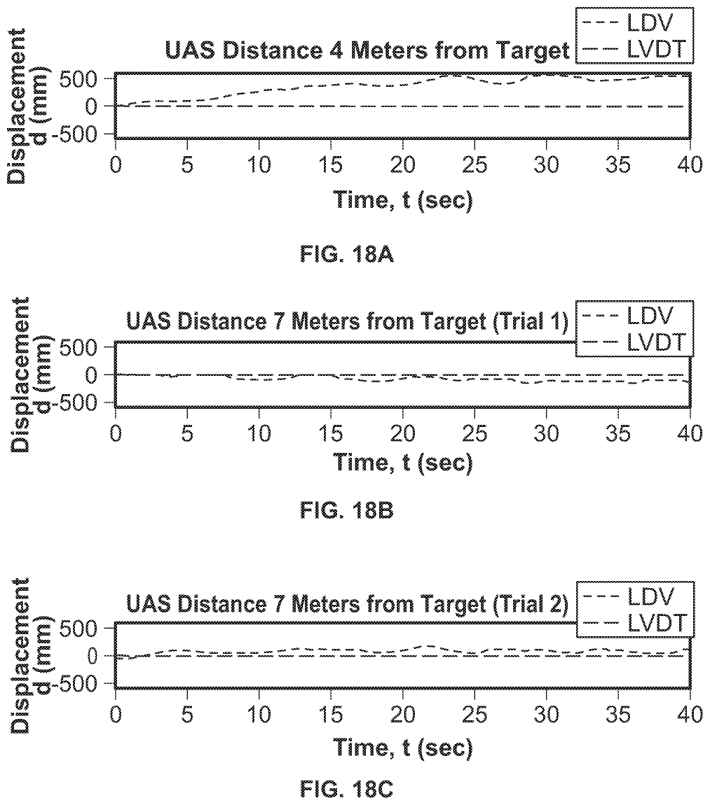

Three trials were conducted in this setup. Of the three trials, one was captured from a distance of four meters from the target, and two from a distance of seven meters from the target. FIG. 18 shows the output signals for the three experiments.

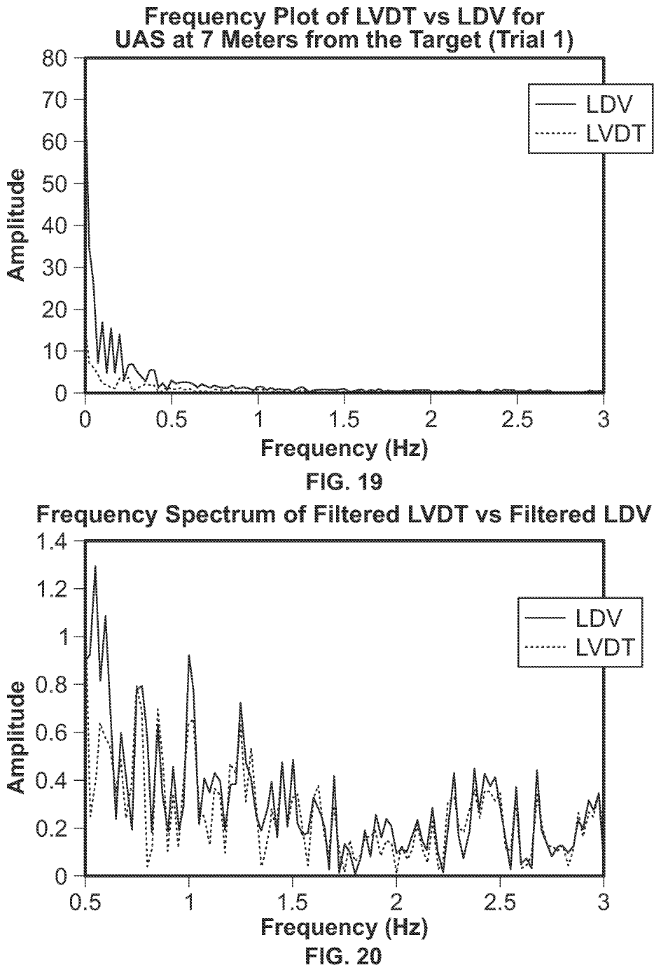

FIG. 18 also revealed that the drifting motion of the UAS of a is very low frequency. The frequency domain analysis of the signals from the vibrometer and the LVDT are is shown in FIG. 19. It can be concluded that the additional frequency components are added to the lower frequencies due to the motion of the UAS. However, at the frequencies greater than 0.5 Hz, the signals from vibrometer as well as the LVDT show similar profile.

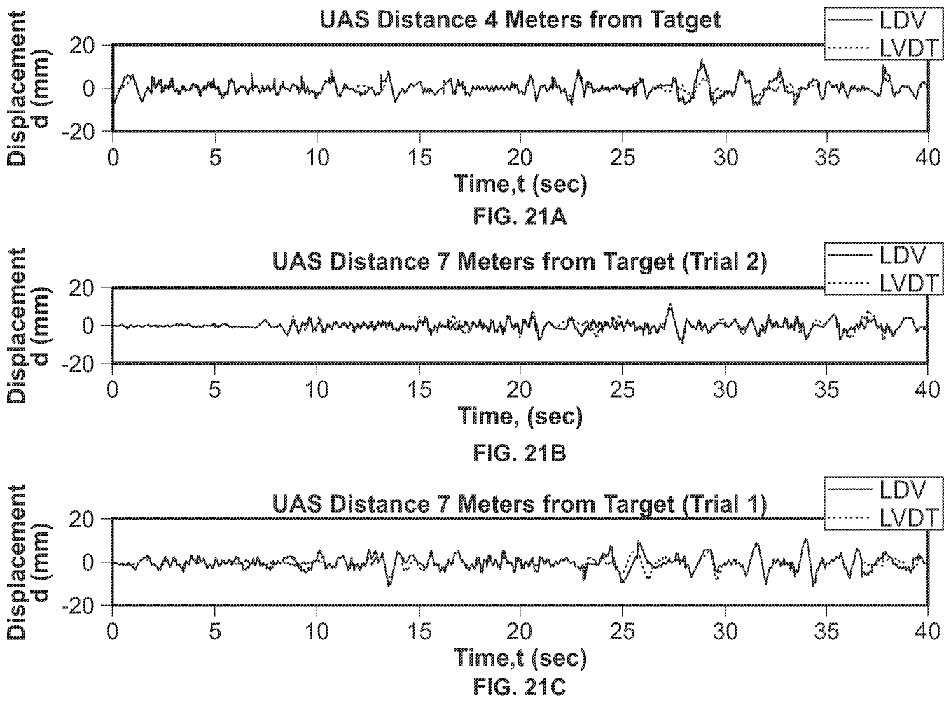

The signals are filtered using a high pass Butterworth filter with a cut off frequency of 0.5 Hz. FIG. 20 shows the frequency spectrum of the vibrometer and LVDT filtered data. The time domain plot of these signals is shown in FIG. 21. It is observed that the filtered signals match very closely. This shows that the dynamic data obtained from a hovering vibrometer matches closely with the dynamic transverse displacement collected using a LVDT.

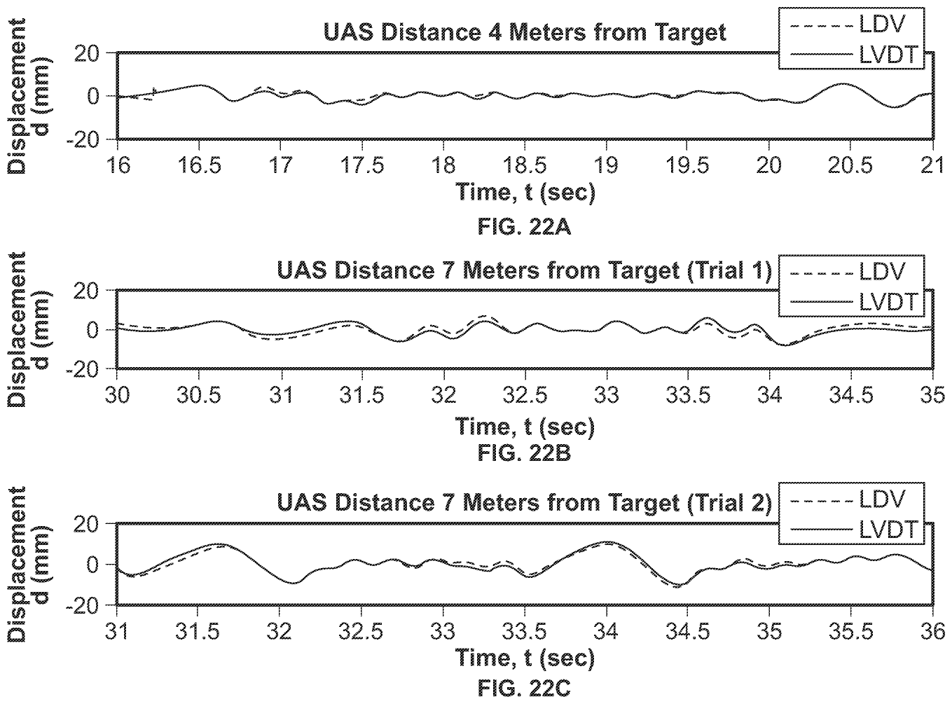

When the filtered signals are enlarged to focus on a specific portion of the data, shown in FIG. 22, it is observed that the two signals matching in both amplitude and phase.

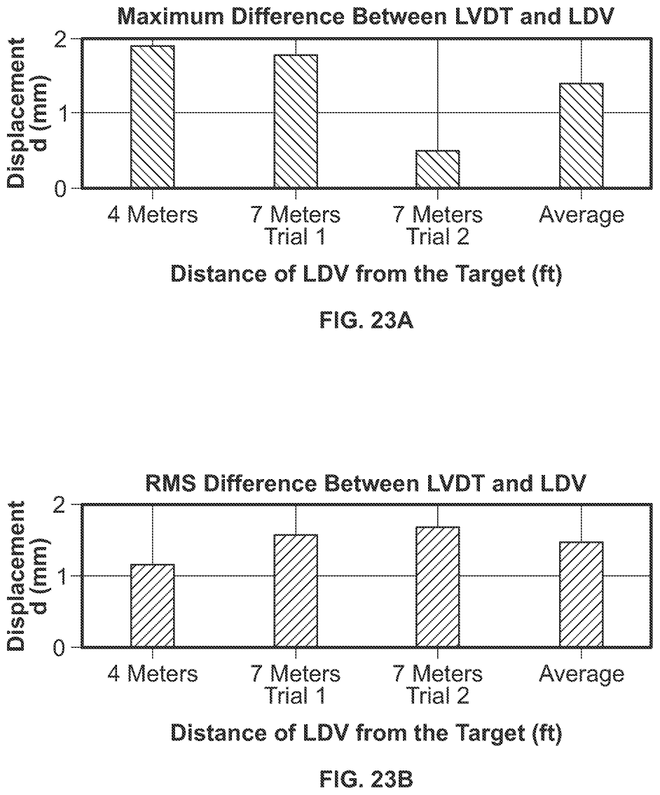

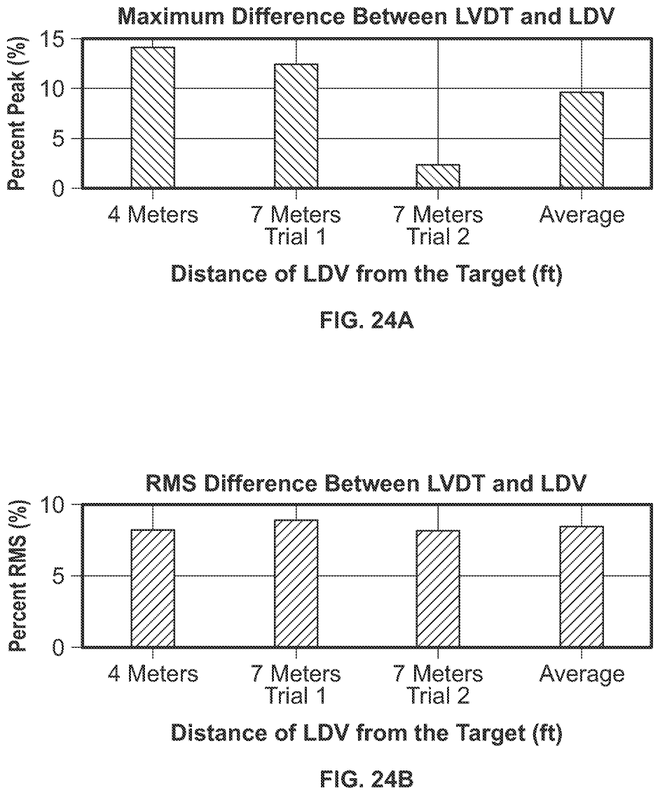

When the signals are compared for peak and RMS differences, it is observed that both the peak as well as RMS difference is less than 2 mm (FIG. 23). FIG. 24 shows that the average output peak error of the three tests is about 10% and the average RMS difference is around 8%. These results are very promising and prove that an LDV mounted on a UAS can be used for monitoring the dynamic transverse bridge displacements under the discussed considerations.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above described embodiments, methods, and examples, but by all embodiments and methods within the scope and spirit of the disclosure.

What is claimed is:

1. A system for measuring the dynamic displacement of a structure reference free comprising: a laser Doppler vibrometer (LDV); an unmanned aerial system (UAS), said LDV mounted on said UAS; and a processor in communication with said LDV adapted to compensate error in the LDV output due to the UAS movement.

2. The system of claim 1 further including one or more non-contact and reference-free moving vibrometers.

3. The system of claim 1 wherein said processor compensates for measurement errors due to the angular and linear movement of said LDV to obtain transverse displacement measurements of a structure.

4. The system of claim 1 wherein said processor includes a signal difference between the measured outputs of a moving LDV system and a LVDT is achieved that is between 10% to 15% peak and 2% to 5% RMS.

5. A method for measuring the dynamic displacement of a structure reference free comprising the steps of: providing a laser Doppler vibrometer (LDV); an unmanned aerial system (UAS), said LDV mounted on said UAS; and a processor in communication with said LDV adapted to compensate error in the LDV output due to the UAS movement.

6. The method of claim 5 further including one or more non-contact and reference-free moving vibrometers.

7. The method of claim 5 wherein said processor compensates for measurement errors due to the angular and linear movement of said LDV to obtain transverse displacement measurements of a structure.

8. The method of claim 5 said processor includes a signal difference between the measured outputs of a moving LDV system and a LVDT is achieved that is between 10% to 15% peak and 2%.

9. The method and system of claim 5 wherein the structure is a bridge.

10. The method and system of claim 5 wherein the structure is in a remote or inaccessible condition.

11. The method and system of claim 5 wherein the bridge is in a remote or inaccessible condition.

12. The method of claim 5 wherein the response of said LDV is analyzed for the motions to which the moving object is subjected.

13. The method of claim 5 wherein one or more algorithms compensate for the errors introduced due to motions of said LDV and the measured signals are corrected.

14. The method of claim 5 wherein outputs show errors of 10% avg and 8% RMS.
